(19) United States
(12) Patent Application Publication
(10) Pub. No.: US 2012/0110475 A1
(43) Pub. Date: May 3, 2012

(54) Dynamically Controlling the Process of an Electronic Meeting

(75) Inventors: Liang Han, Beijing (CN); Su Ying Rui, Beijing (CN); Xing Yu, Beijing (CN); Juan Zhang, Beijing (CN); Xia Zhang, Beijing (CN)

(73) Assignee: INTERNATIONAL BUSINESS MACHINES CORPORATION, Armonk, NY (US)

(21) Appl. No.: 13/271,375

(22) Filed: Oct. 12, 2011

(30) Foreign Application Priority Data
Oct. 28, 2010 (CN) 201010528837.5

(51) Int. Cl. G06F 3/01; G06F 15/16

(52) U.S. Cl. 715/753

(57) ABSTRACT

A mechanism is provided for dynamically controlling the process of an electronic meeting that includes at least two sub-meetings. A monitoring module monitors the occurrence of a trigger event for triggering switching between different sub-meetings in the process of the electronic meeting. A control module breaks the connection between the attendees of the current sub-meeting and the meeting resources defined in the main meeting room of the electronic meeting in response to monitoring the occurrence of the trigger event by the monitoring module. The control module determines the next sub-meeting of the electronic meeting and its attendees according to the meeting agenda, that specifies the sequence of the sub-meetings constituting the meeting and at least one attendee of each sub-meeting. The control module establishes a connection between the attendees of the next sub-meeting and the meeting resources defined in the main meeting room of the electronic meeting.

### BACKGROUND

The present invention relates to electronic meetings, and specifically, to an apparatus and method for dynamically controlling the process of an electronic meeting.

Electronic meeting system makes individuals distributed geographically to participate in various multimedia interactions, including video, sound, image, text and/or other types of electronic data transmission, through computer networks, so as to achieve a face-to-face like communication effect. Electronic meetings are usually realized on servers and clients connected with each other via networks, e.g., Internet, wherein one or more attendees, e.g., the host and ordinary attendees of the meeting, can take part in the electronic meeting service provided by the server from their respective client computers through client software, e.g., a browser.

Specifically, after the meeting host logs onto the electronic meeting system on the server through its client and creates a meeting, he/she sends an invitation for the meeting to all the attendees of the meeting by e-mail, instant message or telephone, the invitation having the information of the meeting, such as the scheduled time period, subject, and presentation documents used in the meeting, etc. At the scheduled start time of the meeting, the meeting attendees log onto the electronic meeting system on their respective clients and enter the meeting room of the meeting. The meeting room, which also can be called meeting context, actually refers to a set of relevant resources of the electronic meeting to which the meeting attendees are authorized to access, including: the presentations that the meeting attendees can see, others' speeches that can be heard, documents that can be browsed, documents that can be downloaded, and information like texts, audios and videos that can be sent. A meeting room usually has a visualized representation on a meeting attendee's client screen.

Some types of electronic meetings, e.g., invention review meetings, may need to review a plurality of inventions made by different reviewees. In such an electronic meeting, some meeting attendees are reviewers, who can attend the entire electronic meeting; and others are reviewees, each of whom can only attend the part related to him or her (which can be referred to as a sub-meeting), and can not attend other reviewee's parts not related to him or her, because the contents of each invention should be confidential to other reviewees than the inventor.

However, in an existing electronic meeting system, once an attendee logs onto the electronic meeting system by means of, e.g., inputting the name and password and enters the meeting room of the electronic meeting, the attendee can directly attend the current sub-meeting, no matter whether or not this sub-meeting is the sub-meeting that he/she belongs to. Since the actual start times and end times of the sub-meetings of the electronic meeting are usually different from the scheduled start times and end times in the meeting invitation, the attendees of a sub-meeting may log onto the electronic meeting system before or after their sub-meeting, and thus attend a sub-meeting that he/she is not supposed to attend, or he/she may be late for attending the sub-meeting which he/she is supposed to attend. When a sub-meeting is over, although the attendees of the sub-meeting should log off, this only depends on the logoff operation of the attendees themselves, and the host or administrator of the meeting can not force the attendees of the sub-meeting to log off.

In an existing electronic meeting system, it is also contemplated that when each sub-meeting of the electronic meeting ends and the next sub-meeting begins, the host or the like notifies every attendee involved in the current sub-meeting to log off the electronic meeting system and notifies every attendee involved in the next sub-meeting to log onto the electronic meeting system by telephone, instant message etc. Such a manner in which the host or the like manually notifies, at different times, each attendee of each sub-meeting to log off or attend sub-meetings is obviously cumbersome, low-efficient and time-consuming. Moreover, this still cannot actually solve the problem that the attendees of one sub-meeting will attend other sub-meetings unconsciously or consciously.

### SUMMARY

In order to overcome the disadvantages in the prior art, the technical solution of the present invention is presented.

According to one aspect of the present invention, there is provided a computer-implemented apparatus for dynamically controlling the process of an electronic meeting, wherein the electronic meeting includes at least two sub-meetings, the apparatus comprising: a monitoring module for monitoring the occurrence of a trigger event for triggering switching between different sub-meetings during the process of the electronic meeting; and a control module for: breaking a connection between attendees of the current sub-meeting and the meeting resources defined in a main meeting room of the electronic meeting in response to monitoring the occurrence of the trigger event by the monitoring module; determining a next sub-meeting of the electronic meeting and its attendees according to a meeting agenda, wherein the meeting agenda specifies a sequence of the sub-meetings constituting the electronic meeting and at least one attendee of each sub-meeting; and establishing a connection between the attendees of the next sub-meeting and the meeting resources defined in the main meeting room.

According to another aspect of the present invention, there is provided a computer-implemented method for dynamically controlling the process of an electronic meeting, wherein the electronic meeting includes at least two sub-meetings, the method comprising: monitoring the occurrence of a trigger event for triggering switching between different sub-meetings in the process of the electronic meeting; breaking a connection between the attendees of the current sub-meeting and the meeting resources defined in the main meeting room of the electronic meeting in response to monitoring the occurrence of the trigger event by the monitoring module; determining a next sub-meeting of the electronic meeting and its attendees according to a meeting agenda, wherein the meeting agenda specifies a sequence of the sub-meetings constituting the electronic meeting and at least one attendee of each sub-meeting; and establishing a connection between the attendees of the next sub-meeting and the meeting resources defined in the main meeting room.

In other illustrative embodiments, a computer program product comprising a computer readable storage medium having a computer readable program is provided. The computer readable program, when executed on a computing device, causes the computing device to perform various ones of, and combinations of, the operations outlined above with regard to the method illustrative embodiment.

Since the apparatus of the present invention automatically kicks out the attendees of the current sub-meeting from the main meeting room and adds the attendees of the next sub-meeting to the main meeting room during the process of the electronic meeting, in response to a monitored trigger event, it realizes dynamic control of the electronic meeting process, and effectively avoids the attendees of a sub-meeting from attending other sub-meetings, and also avoids the low-efficiency and non-effectiveness when of manually notifying attendees of different sub-meetings to attend and log off the sub-meetings.

### BRIEF DESCRIPTION OF THE SEVERAL VIEWS OF THE DRAWINGS

The appended claims set forth the inventive features which are considered characteristic of the present invention. However, the invention itself and its preferred embodiments, additional objects, features and advantages will be better understood by referring to the detailed description of the exemplary embodiments when read in conjunction with the attached drawings, in which:

FIG. 1 shows an operation environment of a computer-implemented apparatus for dynamically controlling the process of an electronic meeting according to an embodiment of the present invention;

FIG. 2 shows a structure block diagram of the computer-implemented apparatus for dynamically controlling the process of an electronic meeting according to an embodiment of the present invention;

FIG. 3 shows a sequence diagram of the operations performed by the computer-implemented apparatus for dynamically controlling the process of an electronic meeting in response to receiving a user logon request according to an embodiment of the present invention;

FIG. 4 schematically shows a format of a meeting agenda used in an embodiment of the present invention;

FIG. 5 shows a sequence diagram of the operations performed by the computer-implemented apparatus for dynamically controlling the process of an electronic meeting in response to a trigger event being monitored according to an embodiment of the present invention;

FIG. 6 shows a schematic diagram of the steps performed by the computer-implemented method for dynamically controlling the process of an electronic meeting in response to receiving a user logon request according to an embodiment of the present invention;

FIG. 7A shows a schematic diagram of the steps performed by the computer-implemented method for dynamically controlling the process of an electronic meeting in response to a trigger event being monitored according to an embodiment of the present invention;

FIG. 7B shows a schematic diagram of the steps performed by the computer-implemented method for dynamically controlling the process of an electronic meeting in response to a trigger event being monitored according to another embodiment of the present invention; and

FIG. 8 schematically shows an exemplary application scenario of the computer-implemented method for dynamically controlling the process of an electronic meeting according to an embodiment of the present invention.

### DETAILED DESCRIPTION

Embodiments of the present invention will now be described with reference to the accompanying drawings. In the following description, numerous details are described to enable the present invention to be fully understood. However, it is obvious to those skilled in the art that the realization of the present invention can exclude some of these details. In addition, it should be appreciated that the present invention is not limited to the described specific embodiments. In contrast, it is contemplated to implement the present invention by using any combination of the following features and elements, no matter whether they involve different embodiments or not. Therefore, the following aspects, features, embodiments and advantages are only illustrative, rather than elements or limitations of the appended claims, unless explicitly stated otherwise in the claims.

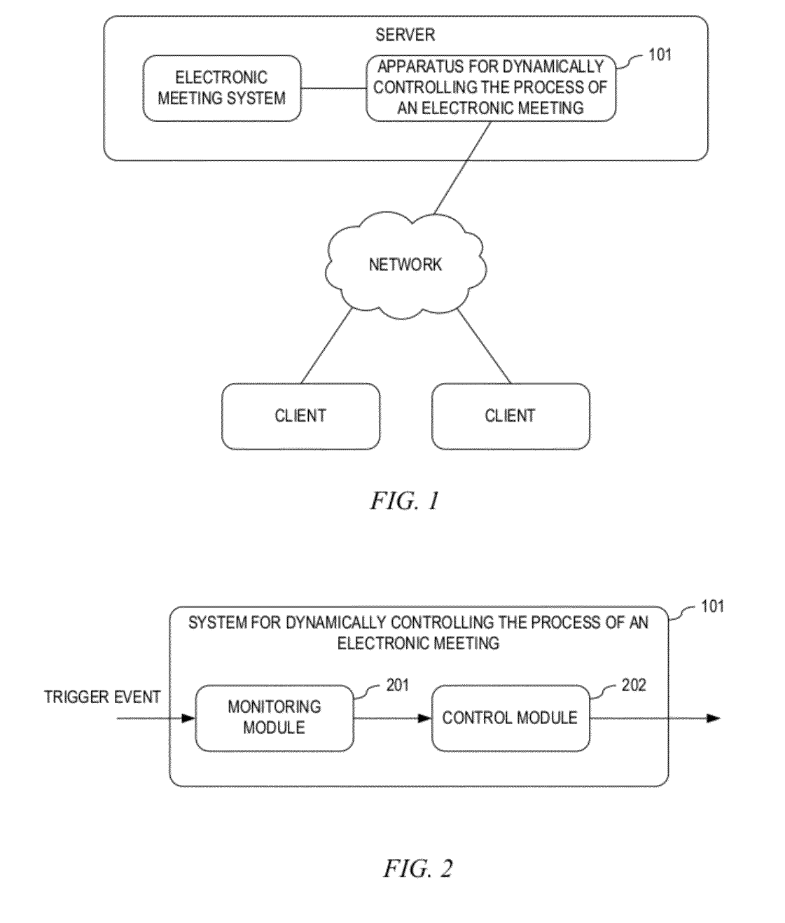

Now referring to FIG. 1, it shows an operation environment of the computer-implemented apparatus for dynamically controlling the process of an electronic meeting according to an embodiment of the present invention. As shown, a plurality of clients are connected to the server via a network, e.g., Internet, the electronic meeting system is on the server, and the attendees or host of the electronic meeting may access the electronic meeting system on the server by their respective clients. The electronic meeting system may be any existing or future electronic meeting system. Preferably, the computer-implemented apparatus 101 for dynamically controlling the process of an electronic meeting according to the embodiment of the present invention resides on the server where the electronic meeting system resides, and is located between the electronic meeting system and the clients connected via the network. The computer-implemented apparatus 101 for dynamically controlling the process of an electronic meeting according to an embodiment of the present invention may either be outside the electronic meeting system as shown in the figure, or be part of the electronic meeting system.

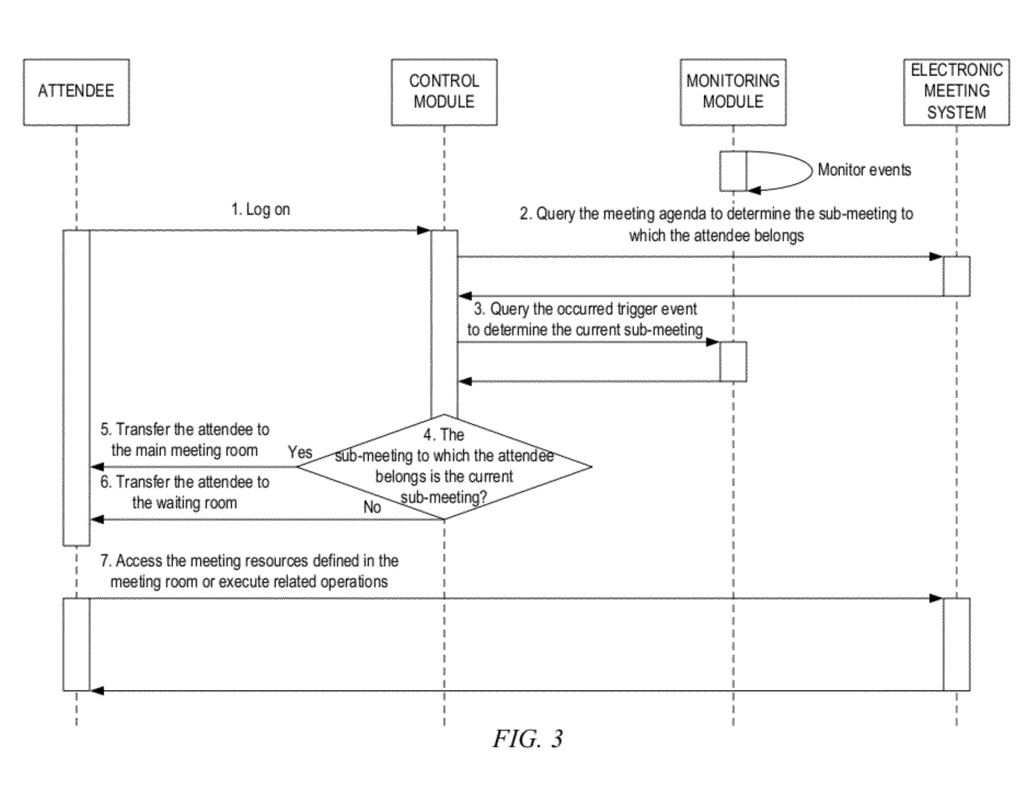

Now referring to FIG. 2, it shows a structure block diagram of the computer-implemented apparatus 101 for dynamically controlling the process of an electronic meeting according to an embodiment of the present invention. As shown, the apparatus includes: a monitoring module 201 for monitoring a trigger event for triggering switching between different sub-meetings in the process of the electronic meeting; and a control module 202 for: breaking the connection between the attendees of the current sub-meeting and the meeting resources defined in the main meeting room of the electronic meeting in response to monitoring the occurrence of the trigger event by the monitoring module; determining the next sub-meeting of the electronic meeting and its attendees according to a meeting agenda, wherein the meeting agenda specifies the sequence of the sub-meetings constituting the meeting and at least one attendee of each sub-meeting; and establishing the connection between the attendees of the next sub-meeting and meeting resources defined in the main meeting room of the electronic meeting.

According to an embodiment of the present invention, the control module 202 is further for: determining the sub-meeting to which a user belongs according to the meeting agenda in response to receiving a request of the user to log onto the electronic meeting; determining whether the sub-meeting to which the user belongs is the current sub-meeting in progress; in response to the determination being yes, establishing a connection between the user and the meeting resources defined in the main meeting room of the electronic meeting; and in response to the determination being no, establishing a connection between the user and the meeting resources defined in a waiting room of the electronic meeting. And according to a further embodiment of the present invention, the control module 202 is further for breaking the connection between the attendees of the next sub-meeting and the meeting resources defined in a waiting room of the electronic meeting before, after or at the same time as establishing the connection between the attendees of the next meeting and the meeting resources defined in the main meeting room of the electronic meeting.

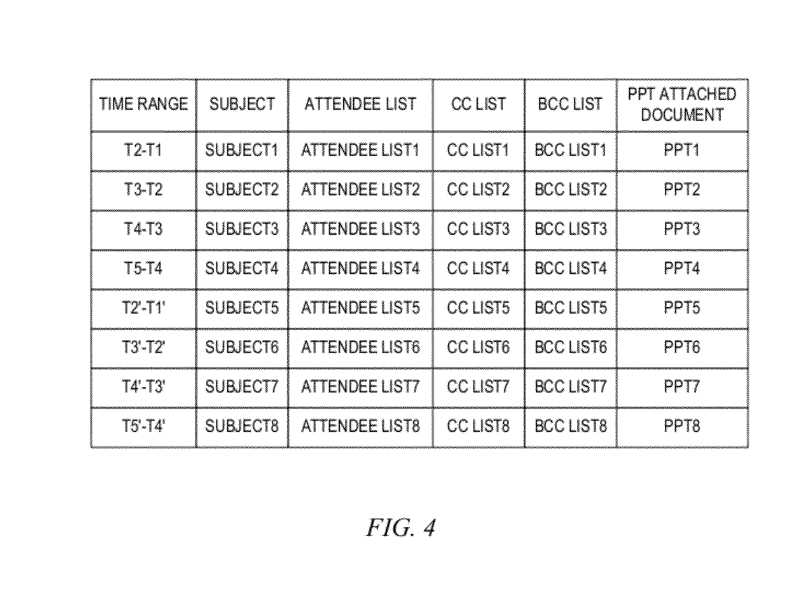

Now referring to FIG. 3, it shows a sequence diagram of the operations performed by the computer-implemented apparatus 101 for dynamically controlling the process of an electronic meeting in response to receiving a user logon request according to an embodiment of the present invention.

As shown, in step 1, the attendees send a logon request to the electronic meeting system by their clients. Since the computer-implemented apparatus 101 for dynamically controlling the process of an electronic meeting according to an embodiment of the present invention is located between the clients of the attendees and the server where the electronic meeting system resides, the logon request is received by the control module 202 in the apparatus 101. As known by those skilled in the art, a logon request usually includes a username and password, and the username and password need to be verified after the logon request is received. Since this belongs to contents of the prior art, this is omitted here.

In step 2, the control module 202 determines the sub-meeting to which the attendee belongs by querying a meeting agenda stored in the electronic meeting system.

The meeting agenda specifies a sequence of the sub-meetings constituting the electronic meeting and the attendees of each sub-meeting, and preferably, it may also specify the scheduled start time and end time of each sub-meeting, and optionally, it may further specify other information like subject, attached documents or attached document page ranges, CC list, BCC list, of each sub-meeting.

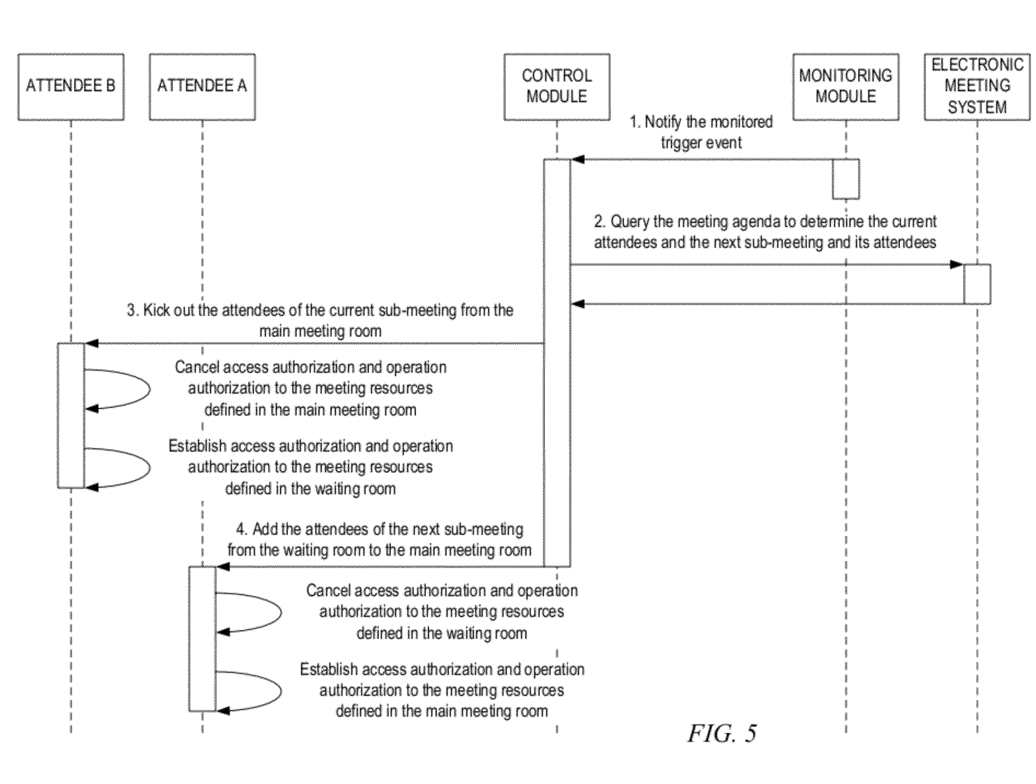

FIG. 4 schematically shows a format of the meeting agenda used in an embodiment of the present invention. As shown, the meeting agenda is a data structure of table, and its columns include “time range”, “subject”, “recipients list” (i.e., attendee list), CC list, BCC list, PPT attached document, and each row represents a sub-meeting in the meeting. For example, the first row represents that the scheduled time rage of the first sub-meeting of the meeting is T2-T1 (i.e., the start time is T1, the end time is T2), the subject is Subject1, the attendee list is Attendee list1, the CC list is CC list1, the BCC list is BCC list1, the PPT attached document is PPT1. The second row represents that the scheduled time rage of the second sub-meeting of the meeting is T3-T2 (i.e., the start time is T2, the end time is T3), the subject is Subject2, the attendee list is Attendee list2, the CC list is CC list2, the BCC list is BCC list2, the PPT attached document is PPT2, and so on. As shown by the exemplary meeting agenda, the subjects, attendees and attached documents of the sub-meetings are different.

As known by those skilled in the art, what FIG. 4 shows is only an example of the format of the meeting agenda used in the embodiment of the present invention. The meeting agenda can absolutely use other formats or data structures, as long as the format or the data structure can represent the information such as the sub-meetings constituting the meeting and the attendees of each sub-meeting. Furthermore, as known by those skilled in the art, the information in the meeting agenda shown in FIG. 4 is not all necessary. For example, the meeting agenda used in some embodiments of the present invention may exclude the CC list column and BCC list column, and may even exclude the time range column, the subject column and the attached document column, and may only include the attendee column. In addition, as known by those skilled in the art, the meeting agenda used in some embodiments of the present invention may further include other information, e.g., a sub-meeting identifier column, a meeting room column, and so on.

The meeting agenda may be created in the electronic meeting system in advance through a meeting agenda creating module by the host or other relevant persons, and stored in the electronic meeting system. The creating module may be a module for creating a meeting agenda in an existing electronic meeting system, a text editing module or data structure creating module in the prior art, or a dedicated meeting agenda creating module in the computer-implemented apparatus 101 for dynamically controlling the process of an electronic meeting according to the embodiment of the present invention.

Now returning to FIG. 3, in step 3, the control module 202 determines the current sub-meeting in progress, for example, by querying the occurred trigger events that have been monitored and stored by the monitoring module 201. In some other embodiments of the present invention, the control module 202 may also determine the current sub-meeting in progress in other ways.

According to an embodiment of the present invention, the trigger event comprises any one of the following: receiving a request for closing an attached document for the current sub-meeting; receiving a request for opening an attached document for the next sub-meeting; detecting that the attached document for the current sub-meeting is closed; detecting that the attached document for the next sub-meeting is opened; receiving a request of turning to an attached document page for the next sub-meeting; detecting turning to an attached document page for the next sub-meeting; and a button for triggering switching between sub-meetings being pressed.

The attached document refers to the document for presentation in the sub-meeting, e.g., a PPT document. In some meetings, different sub-meetings may have different attached documents, in which case, the attached document for the current sub-meeting being closed or receiving the corresponding close request means that the current sub-meeting is over, and thus it may be used as a trigger event for triggering the switching from the current sub-meeting to the next sub-meeting; similarly, the attached document for the next sub-meeting being opened or receiving the corresponding open request means that the next sub-meeting is ready to start, and thus it may also be used as a trigger event for triggering the switching from the current sub-meeting to the next sub-meeting. In some other meetings, different sub-meetings share the same attached document but have different attached document page ranges, in which case, turning from the attached document page range of the current sub-meeting to the attached document page range of the next sub-meeting or receiving the corresponding request means that the current sub-meeting ends and the next sub-meeting starts, and thus it may be used as a trigger event for triggering the switching from the current sub-meeting to the next sub-meeting. Of course, a button may be provided in the apparatus of the present invention for the meeting host or other people to trigger the switching from the current sub-meeting to the next sub-meeting by manually clicking it, and thus manually clicking the button may be used as a trigger event for triggering the switching from the current sub-meeting to the next sub-meeting.

According to an embodiment of the present invention, the computer-implemented apparatus 101 for dynamically controlling the process of an electronic meeting may further includes an optional trigger event designating module for designating a trigger event. The trigger event designating module may be a text editing module or configuration module in the prior art, or may be a dedicated trigger event designating module in the apparatus 101 of the present invention. In some other embodiments of the present invention, the trigger event may be built-in in the computer-implemented apparatus 101 for dynamically controlling the process of an electronic meeting, and does not need to be designated and cannot be changed, thus the apparatus 101 will exclude the trigger event designating module.

Now returning to FIG. 3, in step 4, the control module 202 determines whether the meeting to which the attendee belongs is the current sub-meeting in progress.

In step 5, in response to the above determination being yes, the attendee is transferred to the main meeting room of the electronic meeting. As known by those skilled in the art, the main meeting room of the electronic meeting may be created in advance by, e.g., the host, of the electronic meeting based on the meeting agenda via the electronic meeting system. The main meeting room of the electronic meeting defines a set of meeting resources that the attendees of the electronic meeting are authorized to access. For example, an attendee that enters the main meeting room may view the document presentation of the electronic meeting, hear the speeches of other attendees and raise questions and so on. Therefore, this step actually establishes a connection between the attendee and the meeting resources defined in the main meeting room of the electronic meeting.

In step 6, in response to the above determination being no, the attendee is transferred to a waiting room. The waiting room may be specific to the sub-meeting, i.e., each sub-meeting has its own waiting room, or may be shared by all the sub-meetings of the electronic meeting. The waiting room may be created in advance according to the meeting agenda by the computer-implemented apparatus 101 for dynamically controlling the process of an electronic meeting (for example, by a waiting room creating module included in the apparatus 101). The waiting room defines a group of meeting resources that the attendees entering the waiting room are authorized to access. For example, the attendees entering the waiting room may discuss with each other, but can not watch or hear the presentation or speeches in the main meeting room. Therefore, this step actually establishes a connection between the attendee and the meeting resources defined in the waiting room.

In step 7, the attendees that enter the waiting room or the main meeting room access the meeting resources defined in the waiting room or the main meeting room, respectively.

According to an embodiment of the present invention, the computer-implemented apparatus 101 for dynamically controlling the process of an electronic meeting may further include an optional invitation module for, before the meeting starts, sending invitations for attending the corresponding sub-meetings to the attendees of each sub-meeting. The invitation may be generated according to the above-mentioned meeting agenda. The invitation module sends invitations to the attendees of each sub-meeting according to information of the sub-meeting sequence, subjects, attendees, scheduled start time and end time of each sub-meeting defined in the meeting agenda. Thus, the attendees of each sub-meeting will receive the invitation for attending the sub-meeting that he/she is involved, rather than the invitation for attending the whole meeting. For example, for the exemplary meeting agenda shown in FIG. 4, the invitation to be received by the attendees in the attendee list Attendee list1 are shown as follows:

| Time | | | | | PPT attached |
|---|---|---|---|---|---|
| range | Subject | Attendee list | CC list | BCC list | document |
| T2-T1 | subject1 | Attendee list1 | CC list1 | BCC list1 | PPT1 |

And for the attendees that are supposed to attend both subject2 and subject3 (i.e., the attendees that belong to both Attendee list2 and Attendee list3), they will receive the invitation shown as follows:

| Time | | | | | PPT attached |
|---|---|---|---|---|---|
| range | Subject | Attendee list | CC list | BCC list | document |
| T3-T2 | subject2 | Attendee list2 | CC list2 | BCC list2 | PPT2 |
| T3-T2 | Subject3 | Attendee list3 | CC list3 | BCC list3 | PPT3 |

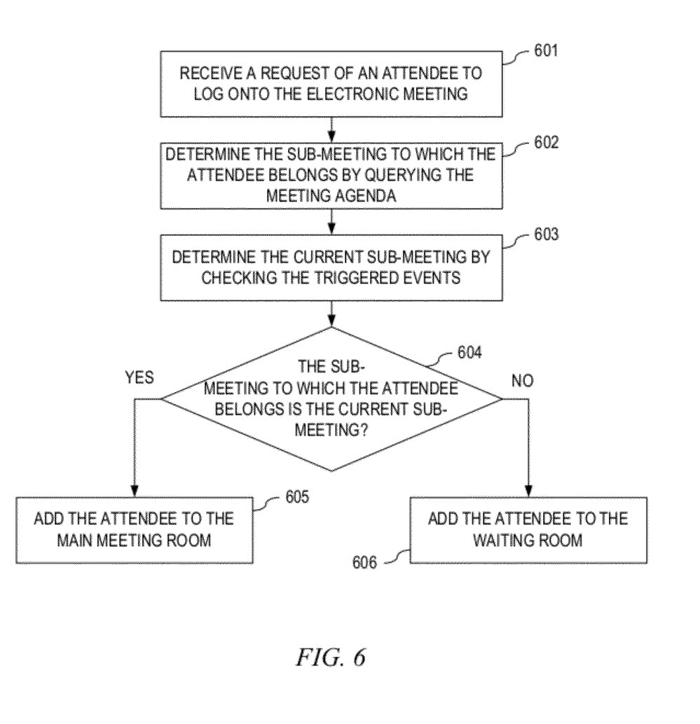

Now referring to FIG. 5, it shows a sequence diagram of the operations performed by the computer-implemented apparatus 101 for dynamically controlling the process of an electronic meeting in response to a trigger event being monitored according to an embodiment of the present invention.

As shown, in step 1, the monitoring module 201 monitors an occurrence of the trigger event, and notifies the occurrence of the trigger event to the control module 202. According to an embodiment of the present invention, the monitoring module 201 will store the monitored trigger event, so as to determine the current progress of the electronic meeting according to the stored trigger events and the meeting agenda.

In step 2, the control module 202 determines the attendees of the current sub-meeting, as well as the next sub-meeting and the attendees of the next sub-meeting by querying the meeting agenda stored in the electronic meeting system.

In step 3, the control module 202 kicks out the attendees (denoted as attendee B in the figure) of the current sub-meeting from the main meeting room, and optionally transfers them to a waiting room of the current sub-meeting. That is to say, it breaks the connection between the attendees of the current sub-meeting and the meeting resources defined in the main meeting room, and optionally establishes a connection between the attendees of the current sub-meeting and the meeting resources defined in the waiting room. Thus, the attendees of the current sub-meeting may no longer access the meeting resources defined in the main meeting room, and is optionally authorized to access the meeting resources in the waiting room. Of course, the control module 202 may also directly log off the attendees of the current sub-meeting from the electronic meeting system.

In step 4, the control module 202 adds the attendees of the next sub-meeting (denoted as attendee A in the figure) to the main meeting room. That is to say, it cancels the access authorization and operation authorization of the attendees of the next sub-meeting to the meeting resources defined in the waiting room, and establishes access authorization and operation authorization of the attendees of the next sub-meeting to the meeting resources defined in the main meeting room. Thus, the attendees of the next sub-meeting will be authorized to access the meeting resources defined in the waiting room and perform relevant operations.

Above is described the computer-implemented apparatus 101 for dynamically controlling the process of an electronic meeting according to an embodiment of the present invention and its operations by referring to the accompanying drawings. It should be pointed out that, the above description is only exemplary, and not limitation to the present invention. In other embodiments of the present invention, the apparatus 101 may have more, less or different modules, and the functions of the respective modules and the operations performed may be different from that is described.

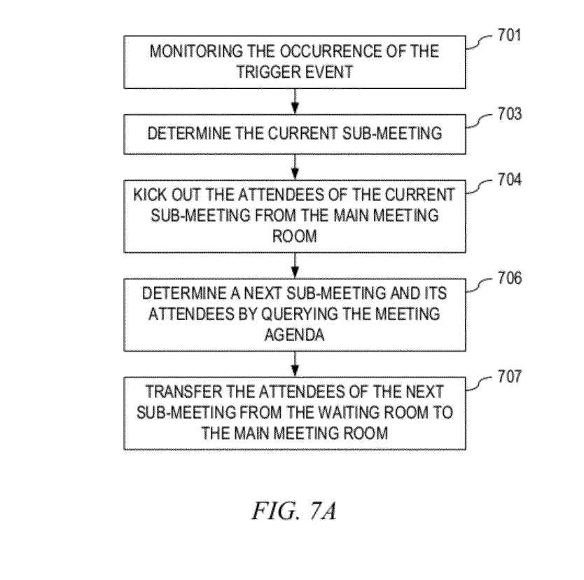

Now referring to FIG. 6, it shows a schematic diagram of the steps performed by the computer-implemented method for dynamically controlling the process of an electronic meeting in response to receiving a user logon request according to an embodiment of the present invention. The steps of the method may be realized by the above described computer-implemented apparatus 101 for dynamically controlling the process of an electronic meeting. For simplicity, some details that are repetitive with the above description are omitted below. Therefore, a more detailed understanding of the steps of the method will be had by referring to the above description.

As shown, in step 601, a request of an attendee to log onto the electronic meeting system is received.

In step 602, the sub-meeting to which the attendee belongs is determined by querying the meeting agenda.

In step 603, the current sub-meeting in progress is determined by checking stored triggered events.

In step 604, it is determined whether the sub-meeting to which the attendee belongs is the current sub-meeting in progress.

At step 605, in response to the determination being yes, the attendee is added to the main meeting room, i.e., establishing a connection between the attendee and the meeting resources defined in the main meeting room.

At step 606, in response to the determination being no, the attendee is added to a waiting room, i.e., establishing a connection between the attendee and the meeting resources defined in the waiting room. Thus, when it is determined by monitoring the trigger event that the sub-meeting to which the attendee belongs starts, the attendee can be transferred from the waiting room to the main meeting room.

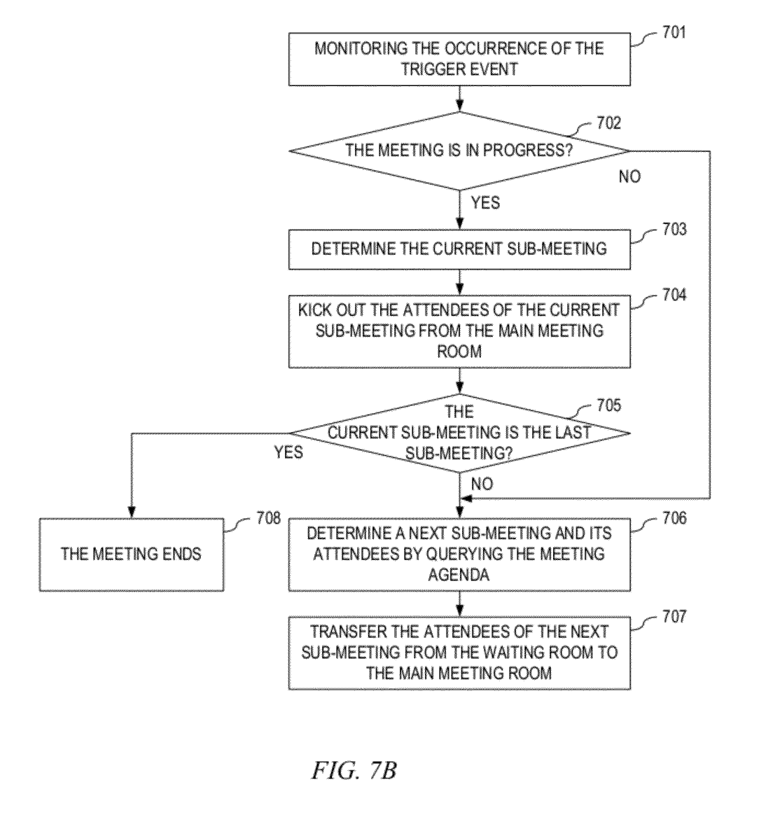

Now referring to FIG. 7A, it shows a schematic diagram of the steps performed by the computer-implemented method for dynamically controlling the process of electronic meeting in response to the occurrence of a trigger event being monitored according to an embodiment of the present invention. The steps of the method may be realized by the above described computer-implemented apparatus 101 for dynamically controlling the process of an electronic meeting according to an embodiment of the present invention. For simplicity, some details that are repetitive with the above description are omitted below. Therefore, a more detailed understanding of the steps of the method will be had by referring to the above description.

In step 701, the trigger event is monitored.

In step 703, the current sub-meeting is determined. For example, the current sub-meeting may be determined by checking the occurred trigger events.

In step 704, the attendees of the current sub-meeting are kicked out from the main meeting room, i.e., breaking the connection between the attendees and the meeting resources defined in the main meeting room.

In step 706, the next sub-meeting and its attendees are determined by querying the meeting agenda.

In step 707, the attendees of the next sub-meeting are transferred from the waiting room to the main meeting room, i.e., breaking the connection between the attendees and the meeting resources defined in the waiting room, and establishing a connection between the attendees and the meeting resources defined in the main meeting room.

Now referring to FIG. 7B, it shows a schematic diagram of the steps performed by the computer-implemented method for dynamically controlling the process of an electronic meeting in response to the occurrence of a trigger event being monitored according to another embodiment of the present invention. The steps of the method may be realized by the above described computer-implemented apparatus 101 for dynamically controlling the process of an electronic meeting according to an embodiment of the present invention. For simplicity, some details that are repetitive with the above description are omitted below. Therefore, a more detailed understanding of the steps of the method will be had by referring to the above description.

In step 701, the trigger event is monitored.

In step 702, it is determined whether the meeting is in progress. There are many ways to determine whether the meeting is in progress, e.g., by querying whether there are monitored and stored trigger events. If the determination is yes, then performing step 703; otherwise, performing step 706.

In step 703, the current sub-meeting is determined. For example, the current sub-meeting may be determined by checking the occurred trigger events.

In step 704, the attendees of the current sub-meeting are kicked out from the main meeting room, i.e., breaking the connection between the attendees and the meeting resources defined in the main meeting room.

According to an embodiment of the present invention, after the attendees of the current sub-meeting are kicked out from the main meeting room, the attendees of the current sub-meeting may be transferred to a waiting room, where the attendees of the current sub-meeting may continue to discuss relevant contents with each other. Of course, in some other embodiments of the present invention, after the attendees of the current sub-meeting are kicked out from the main meeting room, the attendees of the current sub-meeting are logged off from the meeting and the electronic meeting system.

In step 705, it is determined whether the current sub-meeting is the last sub-meeting by querying the meeting agenda. If the determination is yes, then performing step 708, and the meeting ends; if the determination is no, then performing step 706.

In step 706, the next sub-meeting and its attendees are determined by querying the meeting agenda.

In step 707, the attendees of the next sub-meeting are transferred from the waiting room to the main meeting room, i.e., breaking the connection between the attendees and the meeting resources defined in the waiting room, and establishing the connection between the attendees and the meeting resources defined in the main meeting room.

Above is described the computer-implemented method for dynamically controlling the process of an electronic meeting according to an embodiment of the present invention. It should be pointed out that, the above description is only exemplary, and not limitation to the present invention. In some other embodiments of the present invention, the method may have more, less or different steps, and the order among the respective steps may be different from that is described.

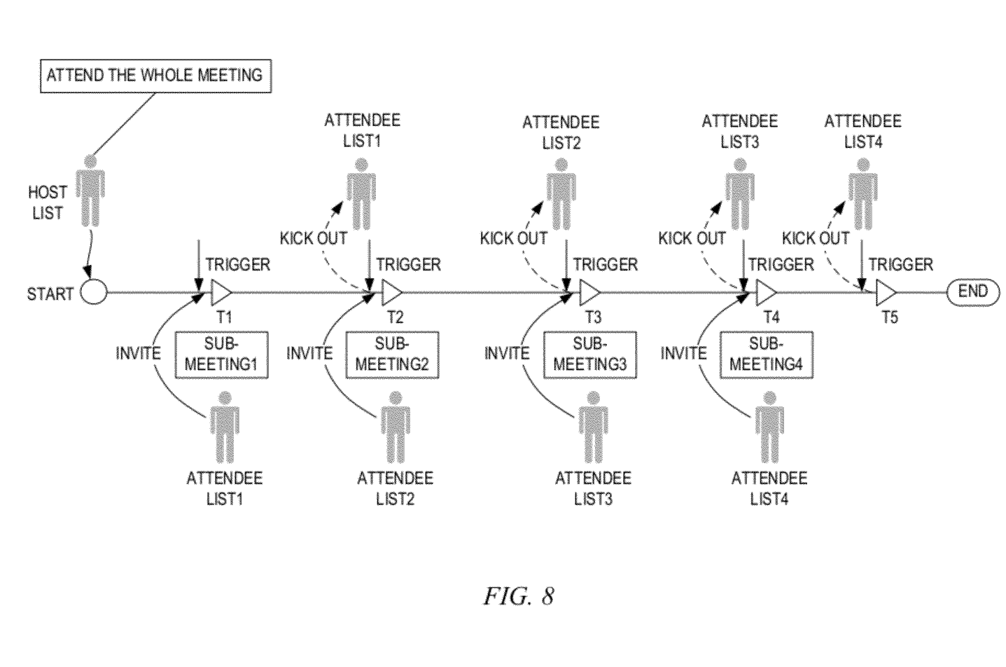

Now referring to FIG. 8, it schematically shows an exemplary application scenario of the computer-implemented method for dynamically controlling the process of an electronic meeting. As shown, the meeting includes a host list that attend the whole meeting, the host list may be designated by including the host list in the attendee list, the CC list or BCC list of each sub-meeting in the meeting agenda, or may be designated outside the meeting agenda. When the trigger event for starting the meeting (this trigger event may be the same as or different from the trigger event for triggering the switching among sub-meetings) is triggered, the apparatus of the present invention invites the attendees in Attendee list1 to attend the sub-meeting Sub-meeting1. The meeting proceeds to sub-meeting Sub-meeting1, and demonstrates PPT1. When the apparatus of the present invention monitors the trigger event for triggering the switching among sub-meetings (for example, receiving a request to close PPT1 or the action of closing PPT1), the apparatus of the present invention kicks out the attendees in Attendee list1, and at the same time invites the attendees in Attendee list2 to attend the sub-meeting Sub-meeting2. The meeting proceeds to sub-meeting Sub-meeting2, and demonstrates PP2. This process continues until a trigger event is received in the last sub-meeting Sub-meeting4 and the Attendee list4 are kicked out. Since the actual start time and end time of the sub-meetings are not as scheduled but triggered by the trigger event in the process of the meeting, they may be dynamically adjusted according to the process of the meeting. For example, if the scheduled end time of the sub-meeting Sub-meeting1 comes, and the discussion of the meeting has not ended yet, the trigger event is not triggered, e.g., PPT1 has not been closed yet. Thus, the attendees in Attendee list2 will not be invited, and the attendees in Attendee list1 are still in the meeting.

The present invention can be realized in hardware, software, or a combination thereof. The present invention can be realized in a computer system in a centralized manner, or in a distributed manner, in which, different components are distributed in some interconnected computer system. Any computer system or other devices suitable for executing the method described herein are appropriate. A typical combination of hardware and software can be a computer system with a computer program, which when being loaded and executed, controls the computer system to execute the method of the present invention, and constitute the apparatus of the present invention.

The present invention can also be embodied in a computer program product, which can realize all the features of the method described herein, and when being loaded into a computer system, can execute the method.

Although the present invention has been illustrated and described with reference to the preferred embodiments, those skilled in the art will understand that various changes both in form and details may be made thereto without departing from the spirit and scope of the present invention.

1. A computer-implemented apparatus for dynamically controlling the process of an electronic meeting, wherein the electronic meeting includes at least two sub-meetings, the apparatus comprising:
a monitoring module for monitoring the occurrence of a trigger event for triggering switching among different sub-meetings in the process of electronic meeting; and
a control module for:
breaking a connection between the attendees of a current sub-meeting and the meeting resources defined in a main meeting room of the electronic meeting in response to monitoring the occurrence of the trigger event by the monitoring module;
determining a next sub-meeting of the electronic meeting and its attendees according to a meeting agenda, wherein the meeting agenda specifies a sequence of the sub-meetings constituting the meeting and at least one attendee of each sub-meeting; and
establishing a connection between the attendees of the next sub-meeting and the meeting resources defined in the main meeting room of the electronic meeting.

2. The apparatus of claim 1, wherein the control module is further for:
determining a sub-meeting to which a user belongs according to the meeting agenda in response to receiving a request of the user to log onto the electronic meeting;
determining whether the sub-meeting to which the user belongs is the current sub-meeting in progress;
responsive to the sub-meeting being the current sub-meeting, establishing a connection between the user and the meeting resources defined in the main meeting room of the electronic meeting; and
responsive to the sub-meeting failing to be the current sub-meeting, establishing a connection between the user and the meeting resources defined in a waiting room of the electronic meeting.

3. The apparatus of claim 2, wherein the control module is further for:
breaking the connection between the attendees of the next sub-meeting and the meeting resources defined in the waiting room of the electronic meeting.

4. The apparatus of claim 1, wherein the meeting agenda specifies the scheduled start time and end time of each sub-meeting.

5. The apparatus of claim 1, wherein the meeting agenda specifies the attached document or attached document pages for the sub-meeting.

6. The apparatus of claim 1, wherein the trigger event includes any one of the following:
receiving a request for closing an attached document of the current sub-meeting;
receiving a request for opening an attached document for the next sub-meeting;
detecting that the attached document for the current sub-meeting is closed;
detecting that the attached document for the next sub-meeting is opened;
receiving a request for turning to an attached document page for a next sub-meeting;
detecting turning to an attached document page for the next sub-meeting; and
a button for triggering switching among sub-meetings being pressed.

7. A computer-implemented method for dynamically controlling the process of an electronic meeting, wherein the electronic meeting includes at least two sub-meetings, the method comprising:
monitoring the occurrence of a trigger event for triggering switching among difference sub-meetings in the process of the electronic meeting;
breaking a connection between the attendees of a current sub-meeting and the meeting resources defined in a main meeting room of the electronic meeting in response to monitoring the occurrence of the trigger event;
determining a next sub-meeting of the electronic meeting and its attendees according to a meeting agenda, wherein the meeting agenda specifies a sequence of the sub-meetings constituting the meeting and at least one attendee of each sub-meeting; and
establishing a connection between the attendees of the next sub-meeting and the meeting resources defined in the main meeting room of the electronic meeting.

8. The method of claim 7, further comprising:
determining a sub-meeting to which a user belongs according to the meeting agenda in response to receiving a request of the user to log onto to the electronic meeting;
determining whether the sub-meeting to which the user belongs is the current sub-meeting in progress;
responsive to the sub-meeting being the current sub-meeting, establishing a connection between the user and the meeting resources defined in the main meeting room of the electronic meeting; and
responsive to the sub-meeting failing to be the current sub-meeting, establishing a connection between the user and the meeting resources defined in a waiting room of the electronic meeting.

9. The method of claim 8, further comprising:
breaking the connection between the attendees of the next sub-meeting and the meeting resources defined in the waiting room of the electronic meeting.

10. The method of claim 7, wherein the meeting agenda specifies the scheduled start time and end time of each sub-meeting.

11. The method of claim 7, wherein the meeting agenda specifies the attached document or attached document pages for the sub-meeting.

12. The method of claim 7, wherein the trigger events include any one of the following:
receiving a request for closing an attached document of the current sub-meeting;
receiving a request for opening an attached document for the next sub-meeting;
detecting that the attached document for the current sub-meeting is closed;
detecting that the attached document for the next sub-meeting is opened;
receiving a request for turning to an attached document page for the next sub-meeting;
detecting turning to an attached document page for the next sub-meeting; and
a button for triggering switching among sub-meetings being pressed.

13. A computer program product comprising a computer readable storage medium having a computer readable program stored therein, wherein the computer readable program, when executed on a computing device, causes the computing device to:
monitor an occurrence of a trigger event for triggering switching among difference sub-meetings in the process of an electronic meeting;
break a connection between the attendees of a current sub-meeting and meeting resources defined in a main meeting room of the electronic meeting in response to monitoring the occurrence of the trigger event;
determining a next-sub-meeting of the electronic meeting and its attendees according to a meeting agenda, wherein the meeting agenda specifies a sequence of the sub-meetings constituting the meeting and at least one attendee of each sub-meeting; and
establishing a connection between the attendees of the next sub-meeting and the meeting resources defined in the main meeting room of the electronic meeting.

14. The computer program product of claim 13, wherein the computer readable program further causes the computing device to:
determine a sub-meeting to which a user belongs according to the meeting agenda in response to receiving a request of the user to log onto to the electronic meeting;
determine whether the sub-meeting to which the user belongs is the current sub-meeting in progress;
responsive to the sub-meeting being the current sub-meeting, establishing a connection between the user and the meeting resources defined in the main meeting room of the electronic meeting; and
responsive to the sub-meeting failing to be the current sub-meeting, establishing a connection between the user and the meeting resources defined in a waiting room of the electronic meeting.

15. The computer program product of claim 14, wherein the computer readable program further causes the computing device to:
break the connection between the attendees of the next sub-meeting and the meeting resources defined in the waiting room of the electronic meeting.

16. The computer program product of claim 13, wherein the meeting agenda specifies the scheduled start time and end time of each sub-meeting.

17. The computer program product of claim 13, wherein the meeting agenda specifies the attached document or attached document pages for the sub-meeting.

18. The computer program product of claim 13, wherein the trigger events include any one of the following:
receiving a request for closing an attached document of the current sub-meeting;
receiving a request for opening an attached document for the next sub-meeting;
detecting that the attached document for the current sub-meeting is closed;
detecting that the attached document for the next sub-meeting is opened;
receiving a request for turning to an attached document page for the next sub-meeting;
detecting turning to an attached document page for the next sub-meeting; and
a button for triggering switching among sub-meetings being, pressed.
